(19) United States
(12) Patent Application Publication
(10) Pub. No.: US 2011/0192616 A1
(43) Pub. Date: Aug. 11, 2011

(54) Sprinkler Apparatus and Method of Placement

(76) Inventor: Benigno M. Gonzalez, Simi Valley, CA (US)

(21) Appl. No.: 12/703,700

(22) Filed: Feb. 10, 2010

(51) Int. Cl. A62C 31/02; B23P 17/04

(52) U.S. Cl. 169/37; 29/428

(57) ABSTRACT

There is disclosed a sprinkler apparatus which may be coupled to an exterior roof of a building, typically a house, in order to provide fire suppression for the exterior of the building. The sprinkler apparatus can substantially withstand the radiant heat from nearby fires. It may be crafted as a single, seamless, unobtrusive unit having a telescoping active sprinkler body that can rotate a full 360 degrees. Further, the sprinkler apparatus may be coupled to an external roof of a building in such a fashion that the longitudinal axis of the sprinkler body forms substantially a 90-degree angle to the plane of the roof.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to a sprinkler apparatus and a method of placement of such an apparatus.

2. Description of the Related Art

Wildfires affected an average of more than four million acres of land in 2003, 2004, and 2005 (or more land than the states of Connecticut and Rhode Island combined.) The fires destroyed many structures built on the edges of the forest, and the worst may be yet to come in future years.

While many structures are protected from internal fires through an interior fire suppression system, such as an interior sprinkler system, structures are often left unprotected from exterior fire threats such as radiant heat generated from a wildfire, a fire in a neighboring structure or burning embers that are blown onto the structure from a nearby fire.

Though solutions have been proposed none have found commercial success. For example many of the proposed fire suppression systems are not aesthetically pleasing and once installed would be considered an eyesore in many communities. The pipes are exposed to the environment, which can lead to corrosion making the system not only unsightly, but also unreliable. In addition, many homes and other structures are designed with roofs having various shapes and slopes that are not contemplated by these limited systems.

### DESCRIPTION OF THE DRAWINGS

FIG. 1 is a cut-away side view of a sprinkler apparatus.

FIG. 2 is a partial side view of a sprinkler apparatus coupled to a structure.

FIG. 3 is a flow chart of a method for coupling a plurality of sprinkler apparatuses on a building.

FIG. 4 is a block diagram of a method for selecting locations for coupling a plurality of sprinkler apparatuses on a building.

Throughout this description, elements appearing in figures are assigned three-digit reference designators, where the most significant digit is the figure number and the two least significant digits are specific to the element. An element that is not described in conjunction with a figure may be presumed to have the same characteristics and function as a previously described element having a reference designator with the same least significant digits.

### DETAILED DESCRIPTION

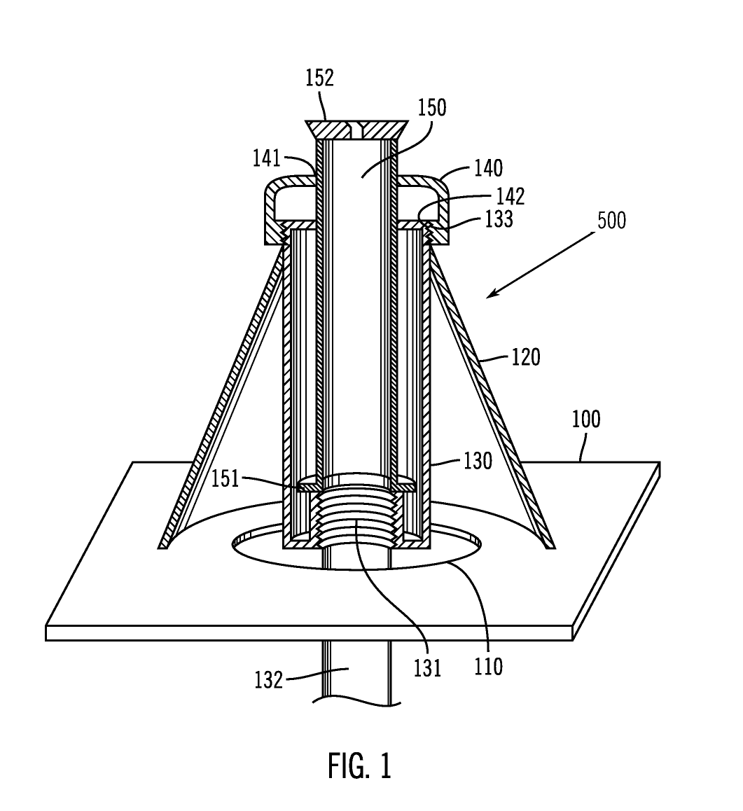

Referring now to FIG. 1 there is shown a cutaway side view of a sprinkler apparatus 500. For convenience of description the sprinkler apparatus 500 and its component parts will be referred to as having top ends and bottom ends, relative to the view of FIG. 1. Though in FIG. 1 the sprinkler apparatus 500 is oriented vertically, the sprinkler apparatus 500 may have a different orientation with concomitant change in relative terms like top and bottom. The sprinkler apparatus 500 includes a spray head 152 and a cap 140 at the top end, a plate 100 at the bottom end, and a riser body 120 and a tubular body 130 extending between the top end and the bottom end. The sprinkler apparatus 500 may be crafted as a single, seamless, unobtrusive unit.

The sprinkler apparatus 500 can substantially withstand the radiant heat from nearby fires. In this regard, the plate 100 may be made of a material that enables the plate to withstand a temperature of at least 811° K without compromise to its structural integrity. The plate 100 may be made from a metal such as stainless steel or galvanized steel, a metal alloy, a ceramic or a ceramic composite. The plate 100 may be made from a single material or a combination of materials that may include at least one of a metal, a metal alloy, a ceramic and a ceramic composite. The exact material of manufacture is not critical to this disclosure beyond its ability to provide the disclosed heat resistance. The materials of the riser body 120 and cap 140 may be selected in the same manner as the materials of the plate 100.

The plate 100 may be substantially flat in order to provide a stable base for the sprinkler apparatus 500 and to provide a surface for coupling the sprinkler apparatus 500 to a building's roof. The plate 100 may have a through hole 110 which may be round. Portions of the plate 100 may be shaped so as to provide for a more secure mounting surface when required by a building's roof.

The riser body 120 may be shaped as a hollow, conical frustum to provide structural strength with minimal weight. The bottom end of the riser body 120 may have a size and shape to entirely surround the through-hole 110 on the plate 100. The riser body 120 may be centered on the through-hole 110, allowing a substantially straight pathway for extinguishant from the bottom to the top of the sprinkler apparatus.

The tubular body 130 may be rigidly coupled to the top of the riser body 120, with at least a portion of the tubular body 130 extending within the riser body 120. The bottom end of the riser body 120 may be rigidly coupled to the plate 100.

At the bottom end of the tubular body 130 may be a fitting 131. The fitting 131 may be connected to an external extinguishant source 132, such as a feeder pipe. The fitting 131 may be accessible to the extinguishant source 132 through the through-hole 110 in the plate 100. The extinguishant may be water and under control of a building's manual or automatic fire suppression system and part of its interior sprinkler system. The connection to a supply of extinguishant may be made using pipes located in the interior of the building to which the sprinkler apparatus 500 is coupled. The tubular body 130 may form an active reservoir from which extinguishant may be expelled during operation.

The top end of the riser body 120 may be secured to the tubular body 130, such as by one or more of a weld, adhesive, friction fit, at least one rivet and at least one screw.

The cap 140 and the top end of the tubular body 130 are securely coupled, for example by respectively mated threads 133, 142 which allow the cap 140 to be detached from the tubular body 130. The cap 140 may be secured to the tubular body 130 in a different removable fashion, such as with the use of a clamp. The cap 140 also has a through-hole 141 having a configuration and make-up to form a seal with the bottom end of the spray head 152. The through-hole 141 allows the hollow shaft 150 to partially emerge from the cap 140 in such a way that the path of the emitted extinguishant is unobstructed by any portion of the sprinkler apparatus. In addition, the security of the cap 140 and the composition of the through-hole 141 are such that when the sprinkler apparatus is fully assembled and operated, extinguishant cannot emerge from any portion of the sprinkler apparatus 500 save via the spray head 152.

The spray head 152 is affixed to a hollow shaft 150. The spray head 152 emits the extinguishant from the apparatus from one or more jet holes (not shown) adapted to direct extinguishant away from the spray head 152 and generally perpendicular to the length of the hollow shaft 150, unobstructed by the sprinkler apparatus 500. Pressure of the extinguishant may be such that the extinguishant is emitted from the spray head 152 with sufficient velocity to reach a distance of about ten feet.

The hollow shaft 150 provides a final conduit for the extinguishant to exit the active reservoir of the tubular body 130. The hollow shaft 150 is disposed to move up and down through the through-hole 141 in the cap 140 and through the tubular body 130. The hollow shaft 150 has a stop 151 configured to prevent the hollow shaft 150 from passing entirely through the through-hole 141. With a decrease in pressure the hollow shaft 150 may retreat into the tubular body 130.

The hollow shaft 150 may be fully rotatable. This rotational action provides a fully circular coverage area of extinguishant by the sprinkler apparatus. This fully circular coverage area allows for suppression of fire in any direction relative to the location of the apparatus and allows for complete fire suppression coverage of an intended area with a minimum number of apparatuses.

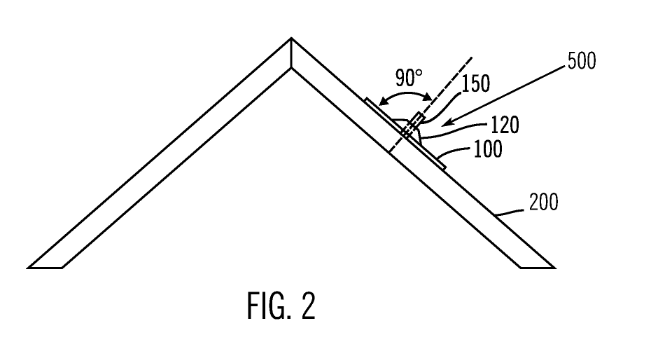

Referring now to FIG. 2 there is shown a partial side view of the sprinkler apparatus coupled to a roof section 200 of a building, such as a house, in order to provide fire suppression for the exterior of the building. Operationally, the sprinkler apparatus emits a spray of extinguishant in order to douse embers or burning particles that are airborne or that land on the roof. By bathing the roof with extinguishant, the roof's flammability is reduced.

A typical building roof is planar and either horizontal or at an angle. Thus, the plate 100 of the sprinkler apparatus 500 may be disposed parallel to the plane of the roof section 200. Since the hollow shaft 150 is disposed normal to the plate 100, the hollow shaft 150 forms substantially a 90-degree angle to the plane of the roof section 200. This 90-degree angle placement allows for a uniform, completely circular spray of extinguishant from the sprinkler apparatus 500. Further, the 90-degree angle placement method provides for this uniform, circular spray regardless of the local pitch of the roof section 200 and the location of additional roof sections and structures. Thus, the sprinkler apparatus 500 may have a low probability of the extinguishant spray being obstructed by any part of a roof structure and, along with the fully rotational nature of the hollow shaft 150, provide efficient, adequate fire suppression coverage with a minimum of both sprinkler apparatuses and extinguishant. A plurality of apparatuses 500 may be located with 20% overlap in coverage between each adjacent apparatus 500 to provide assured extinguishant coverage.

In hot climates, the sprinkler apparatus 500 may be operated to emit a spray of water so as to provide efficient, low energy cooling of the building through evaporative heat exchange. Specifically, the water spray covering the roof section 200 cools the roof section 200 as it evaporates. This evaporative cooling action may cool air beneath the roof section 200, which may then sink into the building providing whole building cooling.

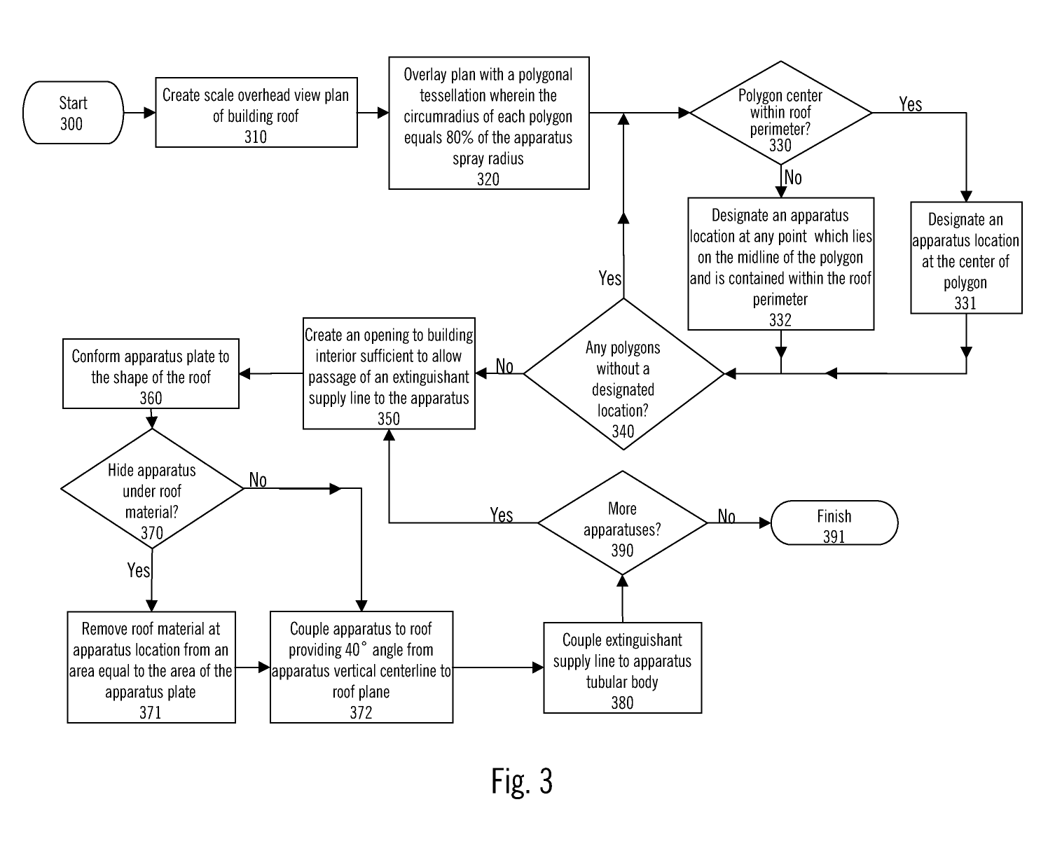

Referring now to FIG. 3 there is shown a flow chart of an exemplary method for coupling a plurality of sprinkler apparatuses on a building. The flow chart of FIG. 3 has a start 300 and a finish 391 when all the sprinkler apparatuses have been placed on a building. The actions 330-340 within the process may be repeated for each of a plurality of sprinkler apparatus locations. The actions 350-390 within the process may be repeated for each of a plurality of sprinkler apparatuses.

At 310, a scale plan of an overhead view of the building is created, such as with computer aided design software or drafting tools. However, the exact method of producing this scale plan is not critical beyond its ability to create an accurate scale depiction of an overhead view of the building.

At 320, the scale plan is overlaid with a regular polygonal tessellation. The exact method of overlaying the scale plan created in step 310 is not critical to this disclosure. The polygons making up the tessellation in step 320 may have any number of sides, must all have the same number of sides and must be simple regular polygons. A regular polygon is a polygon, which is equiangular (all angles are equal in measure) and equilateral (all sides have the same length). A simple polygon is one, which does not intersect itself anywhere. Each polygon may possess a circumradius, which equals 80% of the spray radius of the sprinkler apparatus.

At 330, a determination is made whether the center of the polygon is within the perimeter of a roof of the building as shown on the scale plan of an overhead view of the building. When the center of the polygon is within the perimeter of the scale plan, the process may continue to 331, where the center may be designated a sprinkler apparatus location and the process may continue to 340. When the center of the polygon is not within the perimeter of a roof of the building as shown on the scale plan, the process may continue to 332, where any point on the midline of the polygon which is within the perimeter of a roof of the building as shown on the scale plan may be designated a sprinkler apparatus location and the process may continue to 340.

At 340, a determination is made whether all the polygons of the tessellation possess a designated sprinkler apparatus location interior to them. The actions 330-340 may repeat until all polygons in the tessellation possess a designated sprinkler apparatus location interior to them. When all polygons in the tessellation possess a designated sprinkler apparatus location interior to them, the process may continue to 350.

At 350, an opening may be created through the roof section at the designated location designated. The opening may be of a size to allow for passage of an interior supply line from the extinguishant supply to the sprinkler apparatus.

At 360, the sprinkler apparatus plate 100 may be formed to conform to the shape of the roof 200 at the designated location. The method of conforming the plate 100 to the shape of the roof 200 is not critical beyond its ability to provide continuous contact over the entire area of the plate 100 to the surface.

At 370, a determination is made whether it is desirable to hide the sprinkler apparatus beneath the roof material. This decision may be based on aesthetic reasons. Specifically, it is determined if the plate 100 and the riser body 120 should be substantially covered by the same material as the surrounding roofing material. This material may be for example asphalt shingles, wood shingles, ceramic tiles, or tar and gravel. When it is desired to hide the sprinkler apparatus beneath the roof material, the process may continue to step 371 wherein the roofing material at the designated location of the sprinkler apparatus may be removed and the process may continue to step 372. This roofing material may be prepared to allow it to cover the sprinkler apparatus. The method of preparing the roofing material is not critical to this disclosure beyond its ability to substantially cover the plate 100 and riser body 120 of the sprinkler apparatus while allowing longitudinal motion of the tubular body 130 above the plane of the roof 200. When it is not desired to hide the sprinkler apparatus beneath the roof material, the process may continue to step 372.

At step 372, the sprinkler apparatus may be coupled to the roof by the use of at least one of adhesive, at least one nail, at least one screw, at least one rivet.

At step 380, the extinguishant supply line may be passed through the opening provided at step 350 and may be coupled to the fitting at the bottom end of the tubular body 130 of the sprinkler apparatus.

At step 390, a determination is made whether any designated sprinkler apparatus locations do not have a sprinkler apparatus coupled to the building at that location. The actions 350-390 may repeat until all designated sprinkler apparatus locations have a sprinkler apparatus coupled to the building at that location. The process may finish at 391 when all designated sprinkler apparatus locations have a sprinkler apparatus coupled to the building at that location.

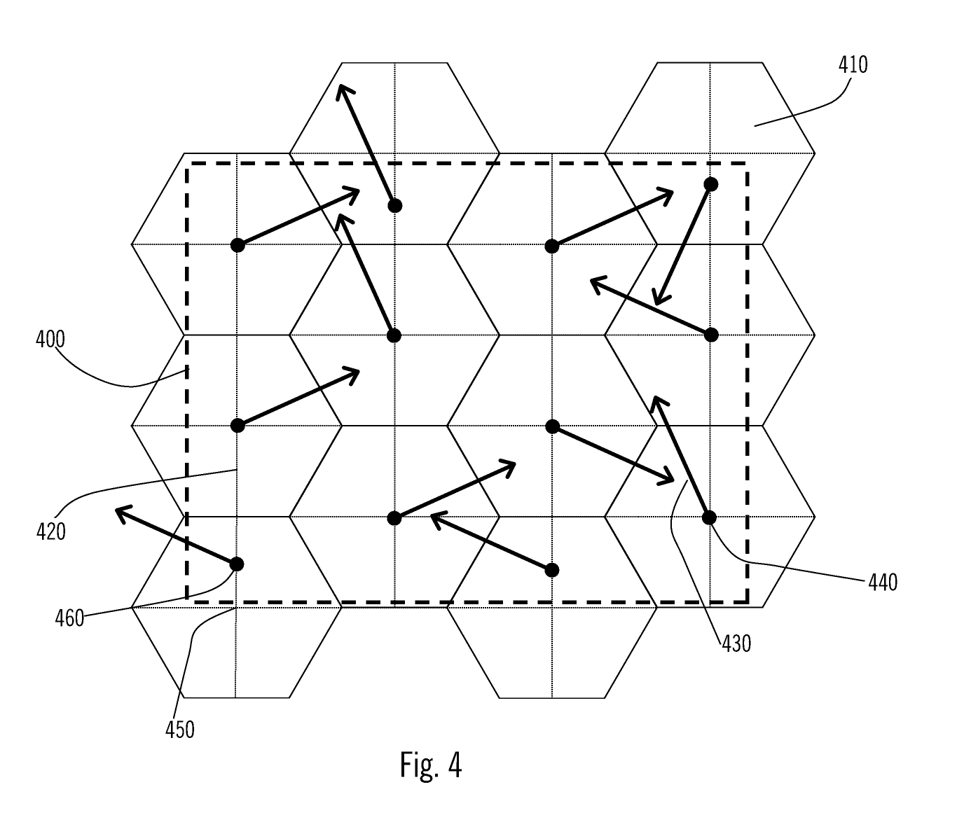

FIG. 4 is a block diagram of an exemplary method of selecting sprinkler apparatus locations. An overhead view of a roof of a building 400 is shown. A tessellation composed of regular, simple 6-sided polygons (hexagons) 410 is overlaid on the overhead view. As previously disclosed, the tessellation may be composed of any regular, simple polygons. The use of hexagons in FIG. 4 is exemplary. Each polygon possesses at least one midline 420 and a midpoint 440. The circumradius of the polygon 430 equals 80% of the spray radius of the sprinkler apparatus. FIG. 4 shows that for any polygon midpoint 440 that is contained within the perimeter of the overhead view of a roof 400, that midpoint 440 is a designated sprinkler apparatus location. Further, for any polygon midpoint 450 that is not within the perimeter of the overhead view of a roof 400, any point 460 lying on one of that polygon's midlines 420 which point is contained within the perimeter of the overhead view of a roof 400, is a designated sprinkler apparatus location.

Closing Comments

As used herein “coupled” means fastened, linked, attached, joined, or connected permanently or semi-permanently by any means. Its use does not exclusively imply the use of a coupling; a device for joining two rotating shafts or a threaded part for connecting two pipes or hoses.

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

As used herein, “and/or” means that the listed items are alternatives, but the alternatives also include any combination of the listed items.

It is claimed:

1. An apparatus comprising a sprinkler apparatus comprising
a plate having a top side and a bottom side and a first through-hole;
a first body disposed around the first through-hole and rigidly coupled to the plate, the first body having a second through-hole aligned with the first through-hole;
a second, tubular body having a top end and a bottom end and an inside and an outside, wherein the tubular body is at least partially disposed within the second through-hole and is rigidly coupled to the first body, the tubular body disposed at about a 90° angle to the plane of the plate, the tubular body having a fitting at the bottom end for connection to an extinguishant supply,
a cap removably secured to the tubular body and having a third through-hole;
a hollow shaft disposed within the tubular body and longitudinally movable therein and at least partially through the third through-hole, the shaft further including a stop to prevent the shaft from passing entirely through the third through-hole;
a spray head at the top of the shaft for outward projection of extinguishant passing through the hollow shaft, the spray head further having one or more jet holes therein.

2. The apparatus of claim 1 wherein the first body is a substantially conical frustum.

3. The apparatus of claim 1 wherein the plate and the first body comprise a single, sealed, rigid unit having an interface between the first body and the plate, which is resistant to the passage of moisture and air between the first body and the plate at the location of coupling.

4. The apparatus of claim 1 wherein the first body is made of a material that possesses a melting point in excess of 811 degrees Kelvin.

5. The apparatus of claim 1 wherein the cap is made of a material that possesses a melting point in excess of 811 degrees Kelvin.

6. The apparatus of claim 1 wherein the plate is made of a material that possesses a melting point in excess of 811 degrees Kelvin.

7. The apparatus of claim 1 wherein the cap is removably secured so as to form a tight seal, which is resistant to the passage of moisture and air between the cap and the tubular body.

8. The apparatus of claim 1 wherein the third through-hole is adapted to allow the spray head to emerge freely.

9. The apparatus of claim 1 wherein the hollow shaft is rotatable.

10. The apparatus of claim 1 wherein a spray from the spray head forms substantially a circle.

11. The apparatus of claim 1 further comprising a building, wherein the sprinkler apparatus is coupled to the building.

12. The apparatus of claim 11 wherein the pop-up sprinkler is coupled to a roof of the building.

13. The apparatus of claim 12 wherein a vertical centerline of the sprinkler apparatus is substantially perpendicular to a plane of the roof.

14. A process for placing a sprinkler apparatus on a building, the process comprising
determining a location for coupling the sprinkler apparatus to the building, wherein the sprinkler apparatus comprises
a plate having a top side and a bottom side and a first through-hole;
a body disposed around the first through-hole and rigidly coupled to the top side of the plate, the body having a second through-hole aligned with the first through-hole;
a tubular body having a top end and a bottom end and an inside and an outside, wherein the tubular body is at least partially disposed within the second through-hole and is rigidly coupled to the body, the tubular body disposed at about a 90° angle to the plane of the plate, the body having a fitting at the bottom end for connection to an extinguishant supply,
a cap removably secured to the top end of the tubular body and having a third through-hole;
a hollow shaft disposed within the tubular body and longitudinally movable therein and at least partially through the third through-hole, the shaft further including a stop to prevent the shaft from passing entirely through the third through-hole;
a spray head at the top of the shaft for outward projection of extinguishant passing through the hollow shaft, the spray head further having one or more jet holes therein;
coupling the apparatus to the building;
connecting the apparatus to an extinguishant supply.

15. The process of claim 14 wherein determining a location for coupling the sprinkler apparatus to the building comprises:
creating a top view plan of the roof, the roof having a perimeter;
overlaying the plan with a polygonal tessellation, wherein each polygon is a regular polygon with a circumradius equal to 80% of the radius of the apparatus spray;
designating a geometric center of each polygon possessing a center point fully contained within the boundaries of the roof perimeter;
designating a location as one point on the midline of each polygon where such a point is fully contained within the boundaries of the roof perimeter where the polygon does not possess a center point fully contained within the boundaries of the roof perimeter

16. The process of claim 14 wherein fashioning the plate comprises
shaping the plate to provide continuous contact over the entire area of the bottom side of the plate with a roof of a building at the location of coupling
shaping the plate to provide a substantially 90° angle between the vertical centerline of the apparatus and the plane of a roof of a building at the location of coupling
